(19) United States
(12) Patent Application Publication
(10) Pub. No.: US 2016/0032939 A1
(43) Pub. Date: Feb. 4, 2016

(54) AIRFOIL STRUCTURES

(71) Applicant: General Electric Company, Schenectady, NY (US)

(72) Inventors: Todd Alan Anderson, Niskayuna, NY (US); Wendy Wen-Ling Lin, Montgomery, OH (US); Pranav Dhoj Shah, Vienna, VA (US); Nicholas Joseph Kray, Mason, OH (US); Ian Francis Prentice, Cincinnati, OH (US); Dong-Jin Shim, Niskayuna, NY (US); Xiaomei Fang, South Glastonbur, CT (US); Ross Ashely Spoonire, Albany, NY (US)

(21) Appl. No.: 14/447,984

(22) Filed: Jul. 31, 2014

(51) Int. Cl. F04D 29/38; B29C 70/34; F04D 19/00

(52) U.S. Cl. CPC F04D 29/388; F04D 19/002; B29C 70/34; B29L 2031/08

(57) ABSTRACT

An airfoil structure includes a composite core including a triaxial braid, wherein the triaxial braid includes a longitudinal axis, a first bias fiber extending in a first bias direction at a first bias angle to the longitudinal axis, a second bias fiber extending in a second bias direction at a second bias angle to the longitudinal axis, and an axial fiber extending in a direction parallel to the longitudinal axis. The airfoil structure further includes an outer layer substantially surrounding the composite core, wherein the outer layer includes a plurality of unidirectional prepreg layers.

### BACKGROUND

The present technology generally relates to airfoil structures. More particularly, the present technology relates to airfoil structures including composite triaxial braided cores.

Composite blades developed for commercial aircraft engine fan blades may be constructed of laminated carbon/epoxy “prepreg” material. A “prepreg” is a layer of carbon fibers filled with resin and arranged to form a tape. Prepreg tape layers may be layered and cured to form a composite structure. The laminates may experience interlaminar separation and/or fiber failure under certain circumstances. When laminated fan blades are subject to high energy impacts (e.g., birds, or other foreign objects), the impact event can result in fiber failure and delamination and a reduction in the blade's structural integrity. Furthermore, fiber failure and delamination can lead to complete separation of portions of the blade, which results in further downstream damage and high engine imbalance loads.

The shear stresses which may tend to delaminate the blade structure are generated when the composite blade is subjected to high twisting and bending loads. These loads normally result from impacts which occur on the leading edge of the blade. When the blade is subjected to an impact, the peak shear stresses tend to be transmitted to the middle of the blade, as well as the leading and trailing edges.

Previous attempts to improve resistance to damage of composite fan blades have involved, for example, stitching a full-sized “all prepreg” blade before cure, or by using 3D woven structures. 3-D type woven structures have been researched extensively to increase the delamination resistance and decrease the damage area during the impact, where a certain number of reinforcement fiber tows were woven in through-thickness direction or partially through-thickness direction. However 3-D woven based blades may have lower stiffness and initial failure strain.

Thus, there is a need for improved airfoil structures that have a combination of desired impact resistance, stiffness and initial failure strain for longer and larger fan blades.

### BRIEF DESCRIPTION

In one example of the present technology an airfoil structure includes a composite core including a triaxial braid, wherein the triaxial braid includes a longitudinal axis, a first bias fiber extending in a first bias direction at a first bias angle to the longitudinal axis, a second bias fiber extending in a second bias direction at a second bias angle to the longitudinal axis, and an axial fiber extending in a direction parallel to the longitudinal axis. The airfoil structure further includes an outer layer substantially surrounding the composite core, wherein the outer layer includes a plurality of unidirectional (UD) prepreg layers.

In another example of the present technology an airfoil structure includes a composite core including a triaxial braid and a first resin, wherein the triaxial braid includes a longitudinal axis, a first bias fiber extending in a first bias direction at a first bias angle to the longitudinal axis, a second bias fiber extending in a second bias direction at a second bias angle to the longitudinal axis, and an axial fiber extending in a direction parallel to the longitudinal axis. The airfoil structure further includes an outer layer substantially surrounding the composite core, wherein the outer layer includes a plurality of unidirectional prepreg layers and a second resin. The airfoil structure further includes an adhesive layer including a third resin disposed between the composite core and the outer layer.

In still another example of the present technology an airfoil structure includes a composite core including a triaxial braid, wherein the triaxial braid includes a longitudinal axis, a first bias fiber extending in a first bias direction at a first bias angle to the longitudinal axis, a second bias fiber extending in a second bias direction at a second bias angle to the longitudinal axis, and an axial fiber extending in a direction parallel to the longitudinal axis. The airfoil structure further includes an outer layer substantially surrounding the composite core, wherein the outer layer includes a plurality of unidirectional prepreg layers; and wherein a modulus ratio of the outer layer to the composite core is greater than 1.1.

### DRAWINGS

These and other features, aspects, and advantages of the present technology will become better understood when the following detailed description is read with reference to the accompanying drawings, wherein:

FIG. 1 is an illustration of an airfoil structure, according to an example of the present technology;

FIG. 2 is a representation of a triaxial braid, according to an example of the present technology;

FIG. 3 is a side elevation schematic of a portion of an airfoil structure, according to an example of the present technology;

FIG. 4 is an illustration of an airfoil structure, according to an example of the present technology;

FIG. 5 is a cutaway view of a leading edge of an airfoil structure, according to an example of the present technology;

FIG. 6 is a cutaway view of a leading edge of an airfoil structure, according to an example of the present technology;

FIG. 7 is a cutaway view of a leading edge of an airfoil structure, according to an example of the present technology;

FIG. 8 is a cutaway view of a leading edge of an airfoil structure, according to an example of the present technology;

FIG. 9 is a schematic of a fan blade, according to an example of the present technology;

FIG. 10 is a schematic of dovetail of the blade, according to an example of the present technology;

FIG. 11 shows the images from impact testing experiments for panels according to an example of the present technology in comparison to comparative panels;

FIG. 12 shows the images from impact testing experiments for panels according to an example of the present technology in comparison to comparative panels;

FIG. 13 shows the images from impact testing experiments for panels according to an example of the present technology in comparison to comparative panels;

FIG. 14 shows the images from impact testing experiments for panels according to an example of the present technology in comparison to comparative panels; and

FIG. 15 shows the images from impact testing experiments for panels according to an example of the present technology in comparison to comparative panels.

### DETAILED DESCRIPTION

In the following specification and the claims, which follow, reference will be made to a number of terms, which shall be defined to have the following meanings. The singular forms “a”, “an” and “the” include plural referents unless the context clearly dictates otherwise. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. Here and throughout the specification and claims, range limitations may be combined and/or interchanged, such ranges are identified and include all the sub-ranges contained therein unless context or language indicates otherwise.

The term “airfoil structure” as used herein refers to a part or surface, whose shape and orientation may control one or more of stability, direction, lift, thrust, or propulsion. Non-limiting examples of suitable airfoil structures include turbine blades (for example, aircraft engine blade, gas turbine blade, or wind turbine blade), compressor blades, fan blades, aircraft wings, and the like. In some examples, the airfoil structure is a fan blade of a gas turbine or an aircraft engine. In other examples, the airfoil structure is an aircraft engine fan blade.

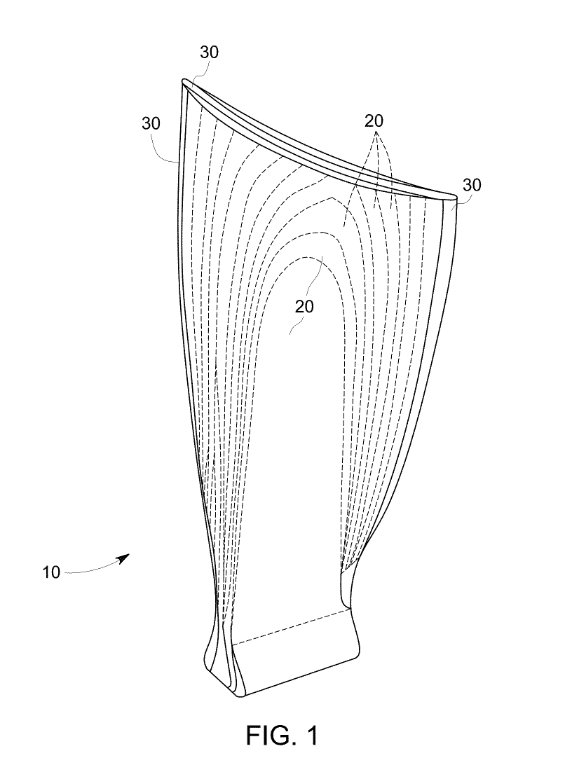

FIG. 1 illustrates an airfoil structure 10 in accordance with an example of the present technology. As shown in FIG. 1, the UD prepreg outer layers 20 (sometimes also referred to as “skins” or “prepreg skins”) are disposed over a composite core 30. The composite core 30 may also be referred to as a “preform”.

The composite core 30 includes a triaxial braid. As used herein, the term “braid” refers to interlaced sets of fibers and the term “triaxial braid” refers to a braid having three interlaced sets of fibers. As used herein, the term “fiber” includes a single fiber, a filament, a thread, or a plurality of fibers, filaments, or threads. The term “fiber” includes untwisted or twisted fibers, filaments, or threads. The term “fiber” also includes a strand, a tow, or a yarn.

A fiber includes a plurality of twisted filaments including a plurality of untwisted filaments or a tow. The term “tow”, as used herein, refers to a plurality of untwisted filaments. A tow may be characterized by a tow size. As used herein, the term “tow size” refers to the number of filaments present within the tow. By way of example, as used herein, a tow size of 12 k refers to a tow containing 12,000 filaments.

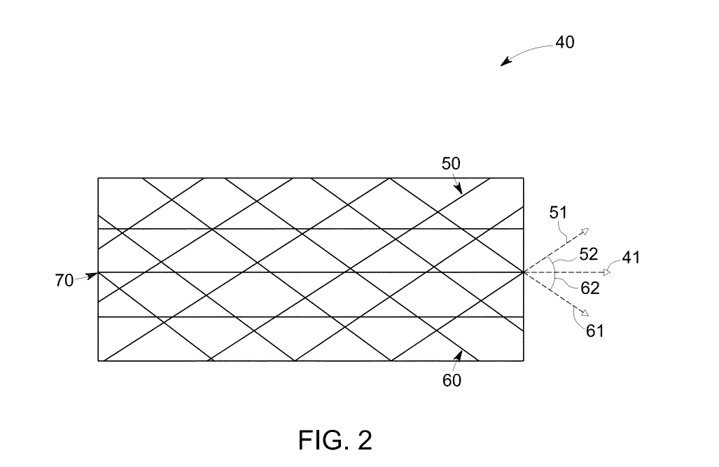

A triaxial braid includes a longitudinal axis, a first bias fiber extending in a first bias direction at a first bias angle to the longitudinal axis, and a second bias fiber extending in a second bias direction at a second bias angle to the longitudinal axis. With reference to FIG. 2, a triaxial braid 40 is characterized by a longitudinal axis 41. The triaxial braid further includes a first bias fiber 50 extending in a first bias direction 51 at a first bias angle 52 to the longitudinal axis and a second bias fiber 60 extending in a second bias direction 61 at a second bias angle 62 to the longitudinal axis. As described herein, the first bias angle 52 is the acute angle measured from the longitudinal braid axis 41 to the first bias fiber 50. Similarly, the second bias angle 62 is the acute angle measured from the longitudinal braid axis 41 to the second bias fiber 60.

The first bias angle 52 may be in a range of from about 15 degrees to about 75 degrees. The first bias angle 52 may be in a range of from about 45 degrees to about 60 degrees. The second bias angle 62 may be in a range of from about 15 degrees to about 75 degrees. The second bias angle 62 may be in a range of from about 45 degrees to about 60 degrees. The first bias angle 52 and the second bias angle 62 may be the same and either one can be used to describe a braid angle. The first bias angle 52 and the second bias angle 62 may be about 60 degrees.

The triaxial braid 40 further includes an axial fiber extending in a direction parallel to the longitudinal axis. With reference to FIG. 2, the triaxial braid 40 includes an axial fiber 70 extending in a direction parallel to the longitudinal axis 41, that is, the acute angle between the axial fiber 70 and the longitudinal axis 41 is about 0 degrees. Axial fibers may also be referred to as warps or unidirectionals or laid-in fibers. The number of axial fibers can be varied. The axial fibers may be spaced equidistantly or regularly or uniformly around the perimeter of the triaxial braid. The axial fibers 70 may be aligned with the span direction of the airfoil structure (e.g, fan blade)

As shown in FIG. 2, the axial fibers 70 are interwoven with the bias fibers 50, 60, with the bias strands passing over and under the axial fibers. The triaxial braid 40 may be braided in a style known as diamond braid in which the bias strands are braided in an over one under one configuration. The triaxial braid 40 may be braided in a style known as regular braid in which the bias strands are braided in an over two, under two configuration. The triaxial braid 40 may be braided in a style known as the hercules braid in which the bias strands are braided in an over three, under three configuration. Any of these braiding styles may be used in FIG. 2.

As described hereinabove, the first bias fiber 50, the second bias fiber 60, and the axial fiber 70 may include a plurality of untwisted filaments or a tow characterized by a tow size. The first bias fiber 50 and the second bias fiber 60 may have a tow size is a range of from about 6 k to about 12 k. The first bias fiber 50 and the second bias fiber 60 may have a tow size of about 12 k. The tow size of the axial fiber 70 may be in a range of from about 12 k to about 24 k. The tow size may be about 24 k.

At least one of the first bias fiber 50, the second bias fiber 60, and the axial fiber 70 may include a glass fiber or a ceramic fiber. At least one of the first bias fiber 50, the second bias fiber 60, and the axial fiber 70 may include a polymer fiber. Suitable examples of fibers include, but are not limited to, glass fibers (for example, quartz, E-glass, S-2 glass, R-glass from suppliers such as PPG, AGY, St. Gobain, Owens-Corning, or Johns Manville), polyester fibers, polyamide fibers (for example, NYLON® polyamide available from E.I. DuPont, Wilmington, Del., USA), aromatic polyamide fibers (such as KEVLAR® aromatic polyamide available from E.I. DuPont, Wilmington, Del., USA; or P84® aromatic polyamide available from Lenzing Aktiengesellschaft, Austria), polyimide fibers (for example, KAPTON® polyimide available from E.I. DuPont, Wilmington, Del., USA), and extended chain polyethylene (for example, SPECTRA® polyethylene from Honeywell International Inc., Morristown, N.J., USA; and DYNEEMA® polyethylene from Toyobo Co., Ltd.).

At least one of the first bias fiber 50, the second bias fiber 60, and the axial fiber 70 may be a tow including a plurality of carbon fibers. Suitable examples of carbon fibers include, but are not limited to, AS2C, AS4, AS4C, AS4D, AS7, IM6, IM7, IM9, and PV42/850 from Hexcel Corporation; TORAYCA T300, T300J, T400H, T600S, T700S, T7000, T800H, T800S, T1000G, M35J, M40J, M46J, M50J, M55J, M60J, M305, M300, and M40from Toray Industries, Inc; HTS12K/24K, G30-500 3K/6K/12K, G30-500 12K, G30-700 12K, G30-700 24K F402, G40-800 24K, STS 24K, HTR 40 F22 24K 1550tex from Toho Tenax, Inc; 34-700, 34-700WD, 34-600, 34-600WD, 34-600 from Grafil Inc.; and T-300, T-650/35, T-300C, T-650/35C from Cytec Industries.

The composite core 30 may further include a first resin such that the triaxial braid 40 is substantially impregnated with the first resin. The term “substantially impregnated” as used herein means that greater than 50 volume percent of the triaxial braid 40 is in contact with the first resin. The term “resin” as used herein throughout in the text refers to uncured material, partially cured material, B-stage material, or completely cured material.

The first resin may be present in the composite core 30 in an amount corresponding to from about 10 weight percent to about 80 weight percent based upon a total weight of the composite core. The first resin may be present in the composite core 30 in an amount corresponding to from about 20 weight percent to about 70 weight percent based upon a total weight of the composite core 30. The triaxial braid 40 may be present in the composite core 30 in an amount corresponding to from about 20 weight percent to about 90 weight percent based upon a total weight of the composite core 30. The triaxial braid 40 may be present in the composite core 30 in an amount corresponding to from about 40 weight percent to about 70 weight percent based upon a total weight of the composite core 30.

The first resin may be selected from a group consisting of epoxy, vinylester, polyimide, bismaleimide, phenol formaldehyde, polyurethane, CBT (cyclic polybutylene terephthalate), and polyester. The first resin may include an epoxy resin. A suitable epoxy resin may include or may be derived from one or more of the following materials: polyhydric phenol polyether alcohols, glycidyl ethers of novolac resins such as epoxylated phenol-formaldehyde novolac resin, glycidyl ethers of mononuclear di-and trihydric phenols, glycidyl ethers of bisphenols such as the diglycidyl ether of tetrabromobisphenol A, glycidyl ethers of polynuclear phenols, glycidyl ethers of aliphatic polyols, glycidyl esters such as aliphatic diacid diglycidyl esters, glycidyl epoxies containing nitrogen such as glycidyl amides and amide-containing epoxies, glycidyl derivatives of cyanuric acid, glycidyl resins from melamines, glycidyl amines such as triglycidyl ether amine of p-aminophenol, glycidyl triazines, thioglycidyl ethers, silicon-containing glycidyl ethers, monoepoxy alcohols, glycidyl aldehyde, 2,2′-diallyl bisphenol A diglycidyl ether, butadiene dioxide, or bis(2,3-epoxycyclopentyl)ether.

A suitable epoxy resin may further include or may be further derived from: octadecylene oxide, epichlorohydrin, styrene oxide, vinylcyclohexene oxide, glycidyl methacrylate, diglycidyl ether of Bisphenol A (for example, those available under the trade designations “EPON 828,” “EPON 1004,” and “EPON 1001 F” from Shell Chemical Co., Houston, Tex., and “DER-332” and “DER-334”, from Dow Chemical Co., Midland, Mich.), diglycidyl ether of Bisphenol F (for example, those under the trade designations “ARALDITE GY281” from Ciba-Geigy Corp., Hawthorne, N.Y., and “EPON 862” from Shell Chemical Co.), vinylcyclohexene dioxide (for example the product designated “ERL 4206” from Union Carbide Corp., Danbury, Conn.), 3,4-epoxycyclohexyl-methyl-3,4-epoxycyclohexene carboxylate (for example the product designated “ERL-4221” from Union Carbide Corp.), 243,4-epoxycyclohexyl-5,5-spiro-3,4-epoxy) cyclohexane-metadioxane (for example the product designated “ERL-4234” from Union Carbide Corp.), bis(3,4-epoxycyclohexyl) adipate (for example the product designated “ERL-4299” from Union Carbide Corp.), dipentene dioxide (for example the product designated “ERL-4269” from Union Carbide Corp.), epoxidized polybutadiene (for example the product designated “OXIRON 2001” from FMC Corp.), epoxy silanes for example, beta-3,4-epoxycyclohexylethyltrimethoxysilane and gamma-glycidyloxypropyltrimethoxysilane, 1,4-butanediol diglycidyl ether (for example the product designated “ARALDITE RD-2” from Ciba-Geigy Corp.), hydrogenated bisphenol A diglycidyl ether (for example the product designated “EPONEX 1510” from Shell Chemical Co.), or polyglycidyl ethers of phenol-formaldehyde novolaks (for example the products designated “DEN-431” and “DEN-438” from Dow Chemical Co.).

Referring again to FIG. 1, the laminate UD prepreg outer layers 20 are layered over the composite core 30 to fill out the airfoil structure 10 (e.g., fan blade structure), and provide the airfoil shape. The UD prepreg outer layers 20 may also add structural stiffness and higher strain capability to the airfoil structure 10. The term “substantially surrounding” as used herein means that at least 80 percent surface area of the composite core is surrounded by the outer layer. At least 95 percent surface area of the composite core may be surrounded by the outer layer. The outer layer 20 and the composite core 30 may be designed such that a modulus ratio of the outer layer 20 to the composite core 30 is greater than 1.1. The modulus ratio of the outer layer 20 to the composite core 30 may be in a range from about 1.1 to about 4.0.

The outer layer 20 may include a second resin. The first resin and the second resin may be the same or different. The second resin may include an epoxy resin as described herein earlier. Non-limiting examples of suitable second resin include HexPly 8551-7, HexPly M91, HexPly 8552, HexPly M21, HexFlow VRM37, HexFlow ST-15, Toray 3900 series resin, CYCOM PR520, CYCOM 977-2, or combinations thereof. One or both of the first resin and the second resin may include a toughening agent. Non-limiting examples of suitable toughening agents include thermoplastic materials such as polysulfone, methacrylates and polyetherimide, and elastomeric materials such as CTBN, silicone, polyurethanes, or combinations thereof.

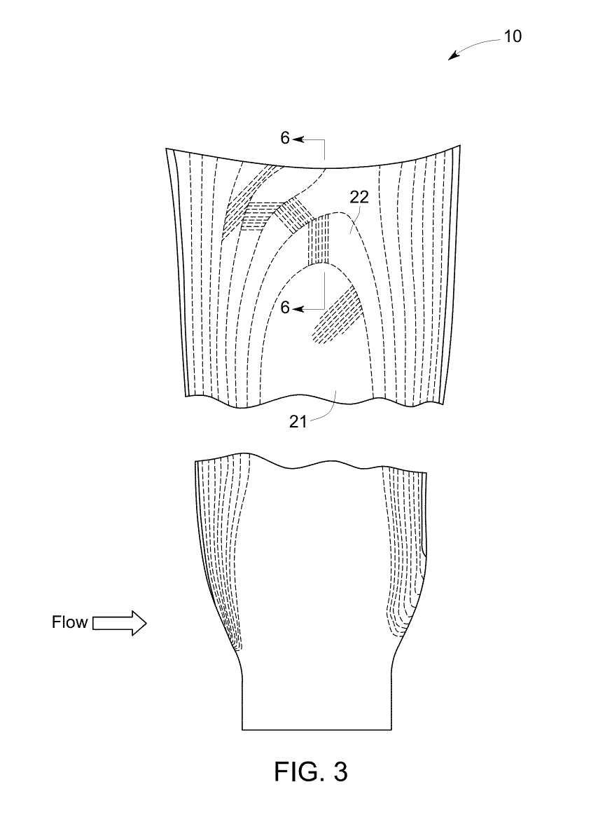

FIG. 3 illustrates the layup of prepreg layers 21, 22 (collectively referred to as “20”) according to the present technology. Prepreg layers may be formed from sheets of unidirectional intermediate modulus, high strain carbon fibers which are coated with resin, as shown in FIG. 3. Prepreg layers take on a “grain” according to the orientation of the fibers. FIG. 3 illustrates an airfoil structure 10 according to the present technology in which the grain orientation of various prepreg layers is shown. As illustrated in FIG. 3, the grain orientation of each prepreg layer may be rotated by approximately 45° with respect to the grain orientation of the adjacent prepreg layers in the stack. For example, the grain of layer 21 is rotated 45° from the grain of layer 22, as illustrated in FIG. 3. By rotating the grain orientation of the adjacent layers, the strength and stiffness of the stack may be customized to the loadbearing requirements of the airfoil structure 10.

A core thickness may be in a range from about 40 percent to about 70 percent of the total airfoil structure thickness. A core thickness may be in a range from about 50 percent to about 60 percent of the total airfoil structure thickness. A total outer layer thickness may be in a range from about 30 percent to about 60 percent of the total airfoil structure thickness. The total outer layer thickness may be in a range from about 40 percent to about 50 percent of the total airfoil structure thickness. The term “total outer layer thickness” as used herein refers to the thickness of the skins on the first and second skin side. The thickness of the skins may be asymmetrical such that the first skin side may have a thickness different from the second skin side.

The braided composite core 30 may include triaxial braids, for example, ±60° (12K)/0° (24K). The braided core 30 may include carbon fibers (for example, T700 (Toray), T800(Toray), or IM7(Hexcel)), which may be impregnated or infused with resins, such as, ST-15 (Hexcel), PR520 (Cytec) or VRM37(Hexcel), and pre-cured or B-staged before being bonded with the UD prepreg outer layers 20.

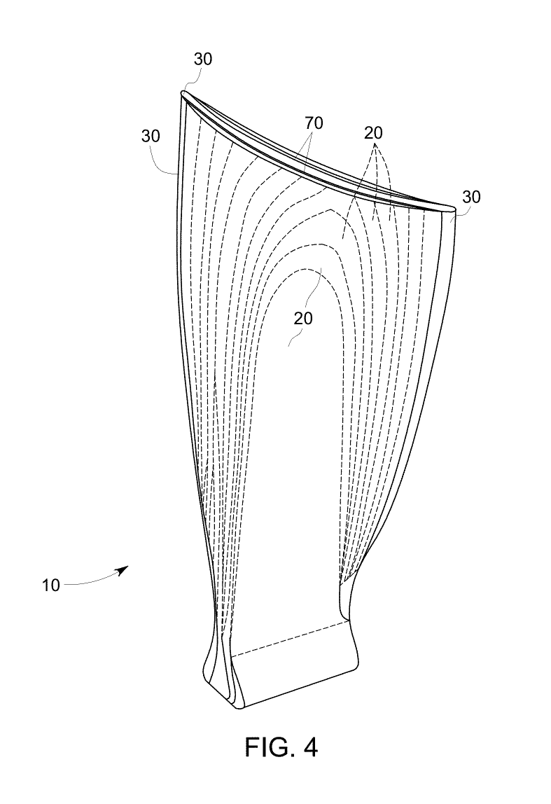

An adhesive layer 80 may be further disposed between the composite core 30 and the outer layer 20, for example, between the innermost prepreg layer 20 and the composite core 30, as shown in FIG. 4. The adhesive layer 80 may include a third resin.

The first resin, the second resin, and the third resin may be the same or different. The adhesive layer 80 may be designed to cure at the same temperature as the prepreg layers 20 and the composite core 30. At least one of the first resin, the second resin, and the third resin includes an epoxy resin. The third resin may include an epoxy resin as described herein earlier. Non-limiting examples of suitable third resin include AF191, AF163, FM 350, FM1000, or combinations thereof.

Without being bound by any theory, it is believed that the triaxial braid structure as a core reinforcement may increase mechanical integrity and reduce fan blade material loss during the high energy impact events from foreign objects and large bird relative to the conventional UD structures (all UD structure or with 3D woven insert). The UD skin may provide the desired stiffness and frequency over woven structures (such as 3D woven structure) for the fan blades, especially for larger blades with longer spans. In addition, as UD laminates have higher strengths compared to woven structures, the placement of the thick UD skins on the outer surfaces of the braid core blade may allow the blade to retain an equally high damage initiation threshold compared to an all UD blade. A tough adhesive layer between the braided core and the UD skins may be desirable for the secondary bonding, where the core is cured and semi-cured beforehand.

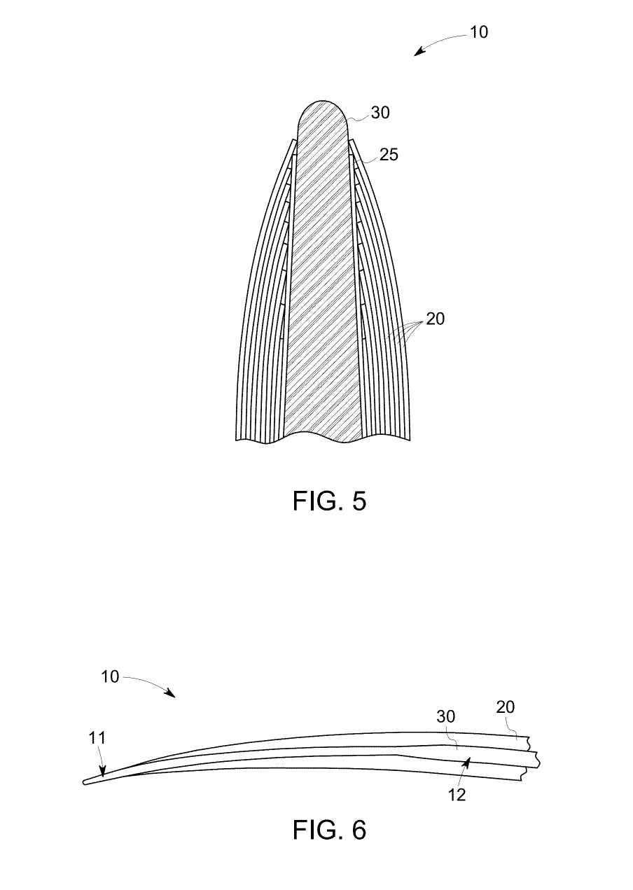

The composite core 30 and the outer layer 20 may have any suitable configuration, as shown in FIGS. 5-8. FIG. 5 is a cutaway view of a leading edge of a blade according to the present technology, wherein the prepreg layers 20 overlie a central composite core 30. FIG. 5, alternatively, is an illustration of a trailing edge of a blade 10 according to the present technology. In FIG. 5, outer prepreg layers 20 are successively shorter with the exception of a transition layer 25, which is longer than every other prepreg layer except the outermost prepreg layer.

In FIG. 5, the transition layer 25 may include, for example, a prepreg layer similar to prepreg layers 10. Alternatively, the transition layer 25 may be a woven non-unidirectional fabric or an adhesive layer. Transition layer 25 may also be referred to as a load transition layer since stresses imposed upon composite core are transitioned through layer 25 to prepreg layers 20 and from prepreg layers 20 to composite core 30.

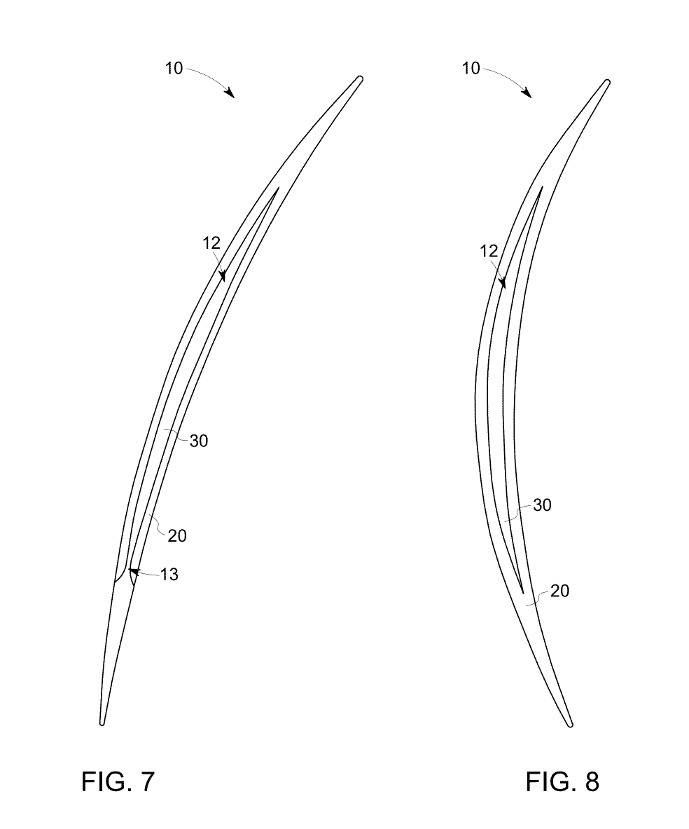

Figures. 6 and 7 illustrate alternatives wherein composite core 30 is surrounded by prepreg layers 20. In FIG. 6, the thickness of composite core 30 is substantially uniform from the tip 11 to the central portion 12. The composite core 30 is thicker in the central portion 12. The trailing edge is not shown but would be substantially identical. In FIG. 7, the composite core 30 narrows rapidly between prepreg layers 20 in region 13 expanding substantially uniformly to the central region 12.

FIG. 8 illustrates an alternative in which the central region 12 is a composite core 30 surrounded by prepreg layers 20. Prepreg layers 20 in such embodiments come together at a camberline of the blade.

A process for manufacturing an airfoil structure includes substantially surrounding a composite core including a triaxial braid with an outer layer, wherein the outer layer includes a plurality of unidirectional prepreg layers. The composite core may include the triaxial braid and a substantially cured first resin. The term “substantially cured’ as used herein means that at least 80 percent of the first resin is cured. The composite core may include the triaxial braid and a b-stage first resin. The composite core may include a prepreg triaxial braid.

The composite core may be provided by curing the triaxial braid and the first resin using resin transfer molding (RTM) process. The composite core may be provided by curing the triaxial braid and the first resin using vaccum assisted resin transfer molding (VARTM) process. As noted earlier, the airfoil structure may further include an adhesive layer. The method may further include providing an adhesive layer between the composite core and the outer layer.

The process may include injecting a triaxial braid with a first resin and partially or fully curing using resin transfer molding (RTM) tool. The triaxial braid, once completed, comprises the core of the airfoil structure 10. The composite core or preform 30 may be resin-transfer-molded and partially or fully cured to form a base for the prepreg layers 20.

The process may further include removing the cured composite from the RTM tooling and transporting it to another tool, and laying the toughened prepreg layers over the cured composite in sequence. This may be done by hand or using a tape laying machine. The prepreg layers and the braided core may be co-cured using conventional autoclave or compression molding technique in the mold to form a rough blade. Finishing operations including cutting and polishing may occur as needed, to form a finished blade.

The airfoil structure may be manufactured using vacuum assisted resin transfer molding (VARTM). In the procedure described herein, a partially or fully-cured composite core is skinned (covered with prepreg layers) with unidirectional prepreg layers. In an alternative embodiment, a dry composite core may be skinned with dry (not pre-pregged) unidirectional fibers. The assembly may be stitched together while dry. Finally, the assembly may be placed in an RTM tool, injected, and completely cured.

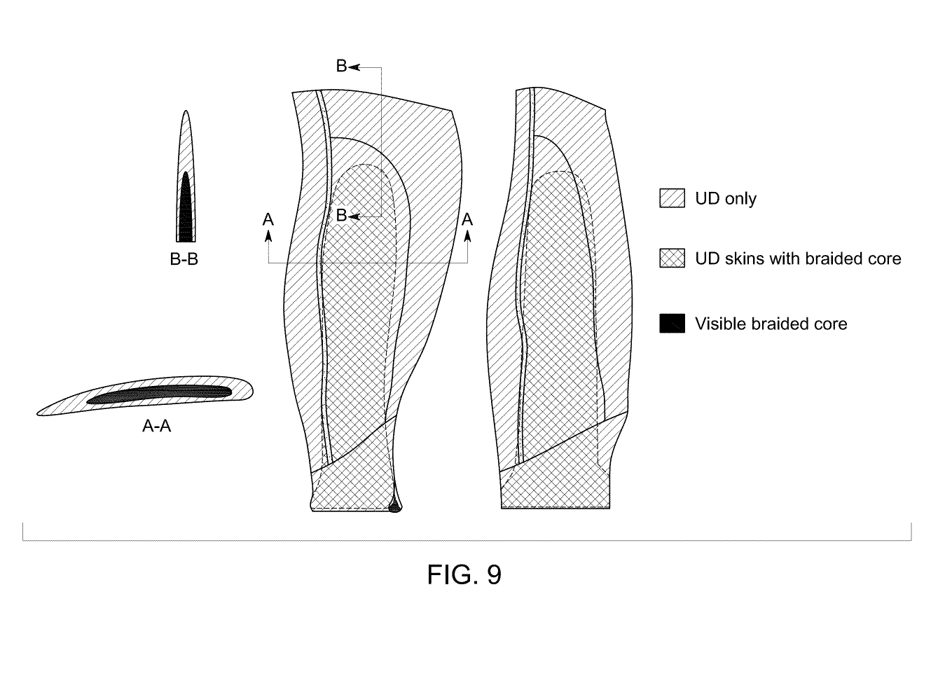

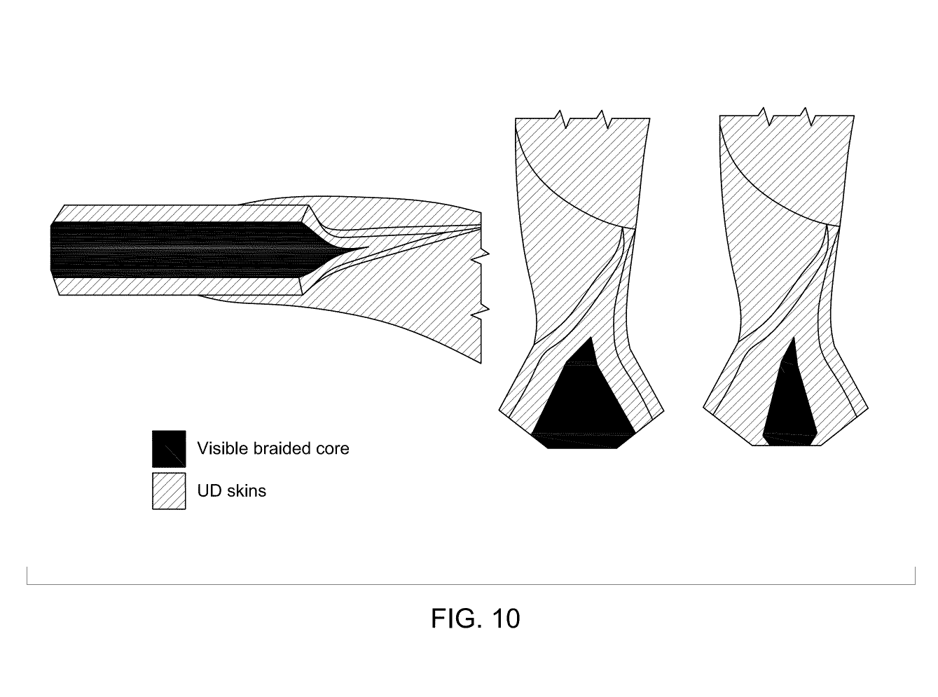

A composite fan blade including the airfoil structure as described herein is also presented. A turbo-engine may include the composite fan blade. As mentioned previously, the airfoil structure may be a component of a fan blade of an aircraft engine. FIG. 9 is a schematic of a fan blade, according to an example of the present technology; and FIG. 10 is a schematic of dovetail of the blade, according to an example of the present technology.

The airfoil structure with braided core and UD skin may provide a fan blade solution with unique combination of high mechanical stiffness behavior and high impact resistance behavior for longer and larger fan blades. The high performance composite fan blades in accordance with the present technology may be particularly desirable in the larger turbo engines, and may provide superior performance over all-UD blades and all-woven blades. Further, the material cost and manufacturing cost of braided core and UD skin may be lower than 3D (including partial 3D) woven blades. The braided core and UD skin may also allow for automated manufacturing process to run layup and thereby further reduce the cost.

### EXAMPLES

The following examples illustrate methods and embodiments in accordance with the present technology.

Epoxy resins PR520 (obtained from Cytec, N.J., USA) or VRM37 (obtained from Hexcel, Stamford, Conn., USA) were used as the resins for all the composites unless specified otherwise. Triaxial braid T700 (from Toray Industries, Inc., Japan) ±60° (12K)/0° (24K) was used as reinforcement to fabricate the triaxial braid-based composites. Unidirectional prepreg tape UD IM7/8551-7 was obtained from Hexcel, Conn., USA).

### Examples 1-2

### Manufacturing of Triaxial Braided-Core Composites

Braided core laminates were manufactured using PR520 resin (Example 1) and VRM37 resin (Example 2) as below:

### Example 1

A dry braided fabric preform was laid up into a resin transfer molding (RTM) tool. The braided fabric was either tackified or stitched to create the preform. Vacuum was applied inside the tool, followed by pre-heating the tool and preform to 160° C., and injecting preheated PR520 resin. The tool, preform, and PR520 were heated and held to a temperature of 180° C. for 2 hours, and curing effected. The cured composite was removed from the tool and a film adhesive was applied to the cured core composite, and debulked. This was followed by laying up a UD tape prepreg on the first skin side, and debulking in an airfoil mold. The cured core composite with adhesive was laid in and debulked. This was followed by laying up a UD tape prepreg on the second skin side, and debulking. This was followed by applying a caul sheet, bagging and curing in an autoclave.

### Example 2

A dry braided fabric preform was laid up into a resin transfer molding (RTM) tool. The braided fabric was either tackified or stitched to create the preform. This was followed by adding infusion mediums, infusion lines, release films, vacuum bag, and applying vacuum. VRM37 was injected at room temperature. The tool, preform, and resin were heated up to 140° C., held at this temperature for 15 minutes, and cooled rapidly to a B-stage resin. The B-staged composite core was removed from tool, and a film adhesive was applied to the B-staged core composite, and debulked. This was followed by laying up a UD tape prepreg on the first skin side, and debulking in a fan blade mold. The B-staged core composite with adhesive was laid in and debulked. This was followed by laying up a UD tape prepreg on the second skin side, and debulking. This was followed by applying a caul sheet, bagging and curing at 180° C. in an autoclave.

### Comparative Examples 1-2

UD prepreg blade (Comparative Example 1) and woven core laminates using PR520 resin (Comparative Example 2) were manufactured as below:

### Comparative Example 1

An initial number of UD tape prepreg plies were laid up and debulked in a fan blade mold. The plies were continuously laid and debulked. This was followed by applying a caul sheet, bagging and curing at 180° C. in an autoclave.

### Comparative Example 2

A dry 3D preform was laid up into a resin transfer molding (RTM) tool. Vacuum was applied inside the tool, followed by pre-heating the tool and preform to 160° C., and injecting preheated PR520 resin. The tool, preform, and PR520 were heated and held to a temperature of 180° C. for 2 hours, and curing effected. The cured composite was removed from the tool and a film adhesive was applied to the cured core composite, and debulked. This was followed by laying up a UD tape prepreg on the first skin side, and debulking in an airfoil mold. The cured core composite with adhesive was laid in and debulked. This was followed by laying up a UD tape prepreg on the second skin side, and debulking. This was followed by applying a caul sheet, bagging and curing in autoclave.

### Impact Testing

To evaluate the impact damage capability of the Examples 1-2 and Comparative Examples 1-2, panels were impacted at varying levels of impact velocity to determine the initiation threshold and post-initiation failure mode. The simply supported panels had a span of 24″ and a width of 6″ and were impacted at the middle of the span. The impacting body was an elastomeric cylinder with a diameter of 4 inches and was fired from a pneumatic cannon. The impactor velocity was measured just prior to impact with the panel, and the event was recorded by video and correlated with strain gage sensors to better understand the failure mechanisms. Subsequent to the test, the panels were inspected for fiber failure and delamination area.

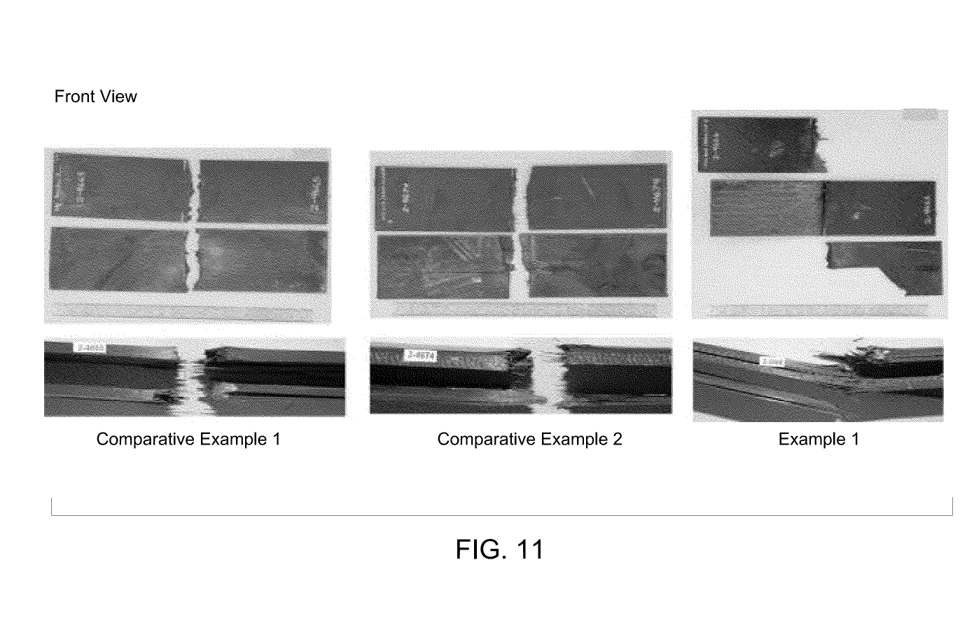

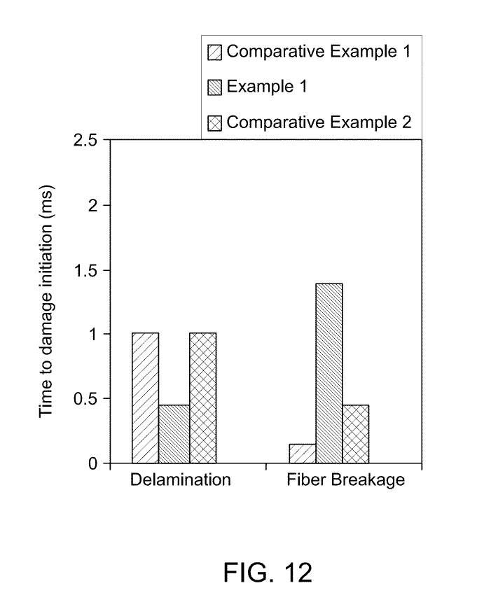

FIG. 11 shows the impact testing results (impact velocity ˜547 ft/s, 0.5″ panel thickness) for Comparative Examples 1-2 and Example 1. As shown in FIG. 11, the Comparative Example 1 (“baseline” unidirectional tape) and Comparative Example 2 (2.5D/3D woven sandwich) break all the way through. Example 1 (braided core sandwich) on the other hand remains continuous and exhibited better damage tolerance as it relates to root to tip blade integrity.

FIG. 12 shows from impact testing (impact velocity ˜547 ft/s, 0.5″ panel thickness) that for Example 1, delamination occurs earlier but the fiber failure either doesn't occur or occurs later (meaning it does not break all the way through) when compared to Comparative Examples 1-2.

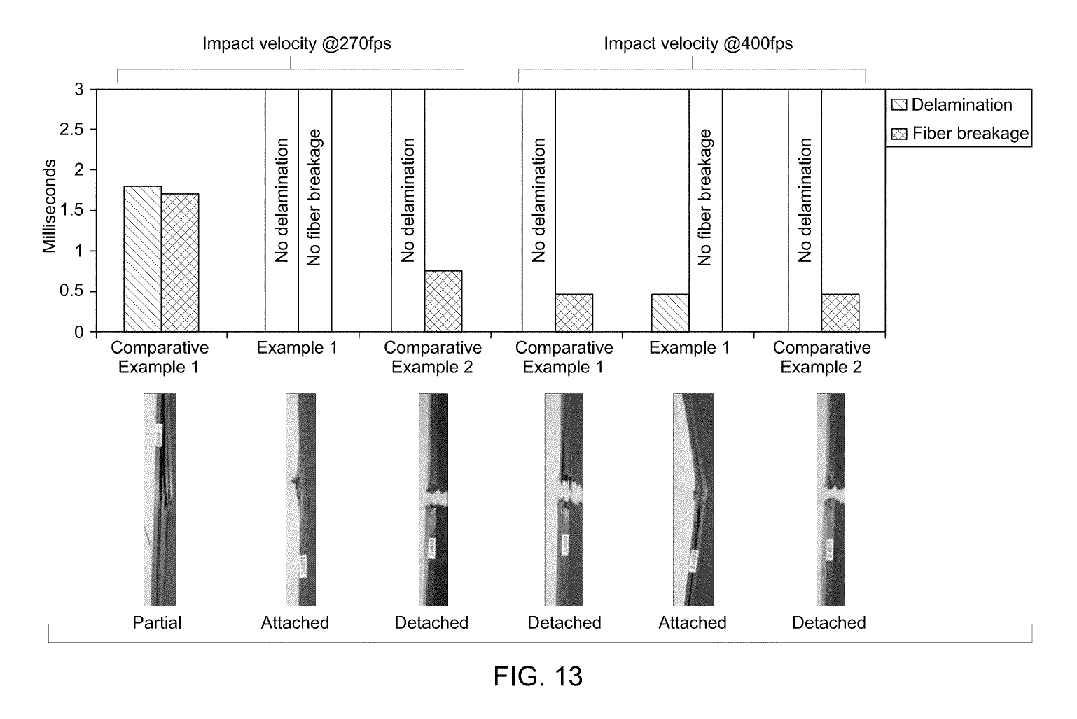

FIG. 13 shows the impact testing results (two different impact velocities ˜270 ft/s and 400 ft/s, 0.25″ panel thickness) for Comparative Examples 1-2 and Example 1. As shown in FIG. 13, the failure modes for Example 1 is different when compared to the Comparative Examples 1 and 2.

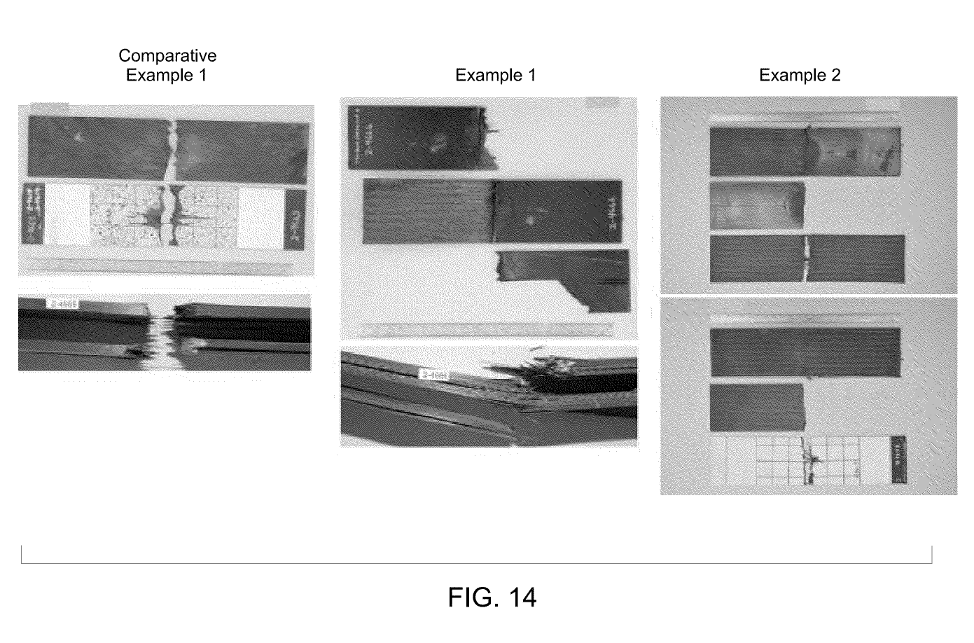

FIG. 14 shows the high impact testing results (impact velocity ˜547 ft/s, 0.5″ panel thickness) for Comparative Example 1 and Examples 1 and 2. As shown in FIG. 14, the Comparative Example 1 (“baseline” unidirectional tape) breaks all the way through. Examples 1 and 2 (braided core sandwich) on the other hand remain continuous and exhibited better damage tolerance, again as it relates to root to tip blade integrity. In the case of Comparative Example 1 the pieces were broken at mid-span and delaminated at center. For Example 1, continuous core was observed and only delamination and fracturing of skins (not at core/skin interface). For Example 2, continuous half of front skin and core was observed; and delamination and fracturing of back skin.

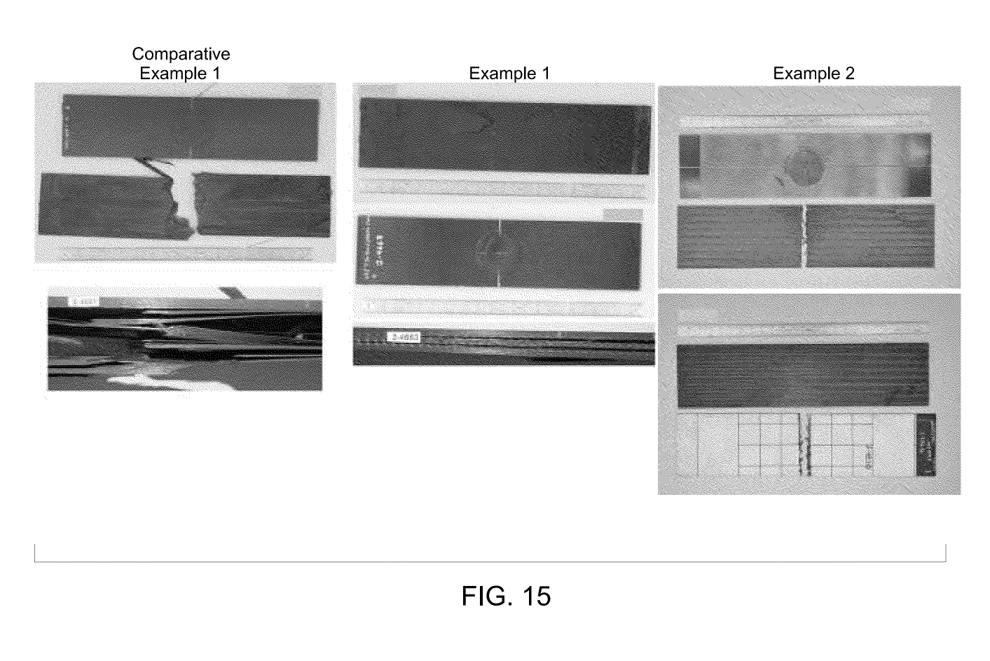

FIG. 15 shows the low impact testing results (impact velocity ˜395 ft/s, 0.5″ panel thickness) for Comparative Example 1 and Examples 1 and 2. As shown there is a significant difference in impact performance of Comparative Example 1 versus Examples 1 and 2.

One of the desirable characteristics for a blade structure is to possess natural vibration frequencies that do not interact with rotation and other interacting harmonic loadings. Generally, this is accomplished by increasing the stiffness of the blade to shift natural frequencies above other driving frequencies. In order to test for the blade stiffness, simulation studies were also carried out for -an all UD laminate blade (Comparative Example 1), a braid core blade (Example 1), and an entirely braided blade. The results were generated using commercial finite element codes to analyze the modal behavior of the blade under rotation. As expected, the all unidirectional prepreg tape blade had the highest first natural frequency. The braid core blade, with a braid core thickness of 50% at mid-chord, possessed natural frequency that corresponded to 94% of the all tape blade. The all braid blade only had a natural frequency of 21% of the first blade. These results demonstrate that the blade structure's damage tolerance can be improved significantly with the introduction of 50% braid core, while only experiencing a small penalty in its natural frequency.

The foregoing examples are merely illustrative, serving to exemplify only some of the features of the present technology. The appended claims are intended to claim the inventions as broadly as permitted and the examples herein presented are illustrative only. Accordingly, the appended claims are not to be limited by the choice of examples utilized to illustrate features of the present technology. As used in the claims, the word “comprises” and its grammatical variants logically also subtend and include phrases of varying and differing extent such as for example, but not limited thereto, “consisting essentially of” and “consisting of.” Where necessary, ranges have been supplied; those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

What is claimed is:

1. An airfoil structure, comprising:
a composite core comprising a triaxial braid, wherein the triaxial braid comprises a longitudinal axis, a first bias fiber extending in a first bias direction at a first bias angle to the longitudinal axis, a second bias fiber extending in a second bias direction at a second bias angle to the longitudinal axis, and an axial fiber extending in a direction parallel to the longitudinal axis; and
an outer layer substantially surrounding the composite core, wherein the outer layer comprises a plurality of unidirectional prepreg layers.

2. The airfoil structure of claim 1 further comprising an adhesive layer disposed between the composite core and the outer layer.

3. The airfoil structure of claim 1, wherein the first bias fiber and the second bias fiber have a tow size is in a range of from about 6 k to about 12 k.

4. The airfoil structure of claim 1, wherein the axial fiber has a tow size in a range of from about 12 k to about 24 k.

5. The airfoil structure of claim 1, wherein the first bias fiber, the second bias fiber, and the axial fiber comprise carbon fibers.

6. The airfoil structure of claim 1, wherein at least one the first bias angle and the second bias angle is in a range of from about 30 degrees to about 75 degrees.

7. The airfoil structure of claim 1, wherein the composite core further comprises a first resin such that the triaxial braid is substantially impregnated with the first resin.

8. The airfoil structure of claim 1, wherein the outer layer further comprises a second resin.

9. The airfoil structure of claim 1, wherein a core thickness is in a range from about 40 percent to about 70 percent of the total airfoil structure thickness.

10. The airfoil structure of claim 1, wherein a total outer layer thickness is in a range from about 30 percent to about 60 percent of the total airfoil structure thickness.

11. The airfoil structure of claim 1, wherein the adhesive layer comprises a third resin.

12. A composite fan blade comprising the airfoil structure of claim 1.

13. A turbo-engine comprising the composite fan blade of claim 12.

14. An airfoil structure, comprising:
a composite core comprising a triaxial braid, wherein the triaxial braid comprises a longitudinal axis, a first bias fiber extending in a first bias direction at a first bias angle to the longitudinal axis, a second bias fiber extending in a second bias direction at a second bias angle to the longitudinal axis, and an axial fiber extending in a direction parallel to the longitudinal axis; and
an outer layer substantially surrounding the composite core, wherein the outer layer comprises a plurality of unidirectional prepreg layers;
wherein a modulus ratio of the outer layer to the composite core is greater than 1.1.

15. The airfoil structure of claim 14, wherein the modulus ratio is in a range from about 1.1 to about 4.0.

16. The airfoil structure of claim 14, wherein a core thickness is in a range from about 40 percent to about 70 percent of the total airfoil structure thickness.

17. The airfoil structure of claim 14, wherein a total outer layer thickness is in a range from about 30 percent to about 60 percent of the total airfoil structure thickness.

18. A method of manufacturing an airfoil structure, comprising:
substantially surrounding a composite core with an outer layer, wherein the triaxial braid comprises a longitudinal axis, a first bias fiber extending in a first bias direction at a first bias angle to the longitudinal axis, a second bias fiber extending in a second bias direction at a second bias angle to the longitudinal axis, and an axial fiber extending in a direction parallel to the longitudinal axis, and wherein the outer layer comprises a plurality of unidirectional prepreg layers.

19. The method of claim 18, wherein the composite core comprises a triaxial braid and a substantially cured first resin.

20. The method of claim 19, wherein the composite core is formed by curing the triaxial braid and the first resin using resin transfer molding process.

21. The method of claim 18, wherein the composite core comprises the triaxial braid and a b-stage first resin.

22. The method of claim 21, wherein the composite core is formed by curing the triaxial braid and the first resin using vaccum assisted resin transfer molding.

23. The method of claim 18, wherein the composite core comprises a prepreg triaxial braid.

24. The method of claim 18, further comprising providing an adhesive layer between the composite core and the outer layer.
